(19) United States
(12) Patent Application Publication
(10) Pub. No.: US 2024/0394327 A1
(43) Pub. Date: Nov. 28, 2024

(54) Real-Time Robust Multivariate Estimator for Dynamic Systems

(71) Applicants: Jason Lee Speyer, Los Angeles, CA (US); Moshe Idan, Haifa (IL); Nathaniel Snyder, Oakland, CA (US)

(72) Inventors: Jason Lee Speyer, Los Angeles, CA (US); Moshe Idan, Haifa (IL); Nathaniel Snyder, Oakland, CA (US)

(21) Appl. No.: 18/674,127

(22) Filed: May 24, 2024

Related U.S. Application Data
(60) Provisional application No. 63/504,176, filed on May 24, 2023.

(51) Int. Cl. G06F 17/11

(52) U.S. Cl. CPC G06F 17/11

(57) ABSTRACT

Systems and methods for solving multivariate state-estimation problems in accordance with numerous embodiments of the invention are illustrated. One embodiment includes a method that develops a characteristic function associated with a state-estimation problem. The method collects, for a set including at least one time point, from a sensory instrument, a set of measurements reflecting the state corresponding to the most recent time point. The method derives, from the set of measurements, new parameters corresponding to the state of the system at the most recent time point. The method updates a hyperplane arrangement based on the new parameters. The method runs a cell-enumeration algorithm based on the hyperplane arrangement to obtain sign vectors for each cell of the hyperplane arrangement. The method determines, based at least in part on the sign vectors, function parameters for the updated characteristic function, wherein the updated characteristic function includes a linear combination of sign vectors.

### STATEMENT OF FEDERAL SUPPORT

This invention was made with government support under Grant Number 1607502 and 1934467, awarded by the National Science Foundation. The government has certain rights in the invention.

### FIELD OF THE INVENTION

The present invention generally relates to parameterizing characterizing functions and, more specifically, parameterizing Multivariate Cauchy Estimator functions.

### BACKGROUND

In numerous engineering, economic, and science-based applications, underlying random processes have significant volatility in terms of fluctuation in probability. Volatility to a particular degree can decrease the efficacy of light-tailed probability distributions, with minimal variance, such as Gaussian/Normal distributions. Heavy-tailed distributions, with “infinite variance” and relatively high probability of outliers, such as Cauchy distributions, have been proven to better represent these volatile random fluctuations. As a result, Cauchy distributions are considered more reliable in cases where the mean and/or variance is unknown. This occurs in measuring distributions of the energy of unstable states in quantum mechanics and distributions of radar noise. In particular, since the heavy tails of a Cauchy distribution over-bound most realistic densities, estimators based on Cauchy pdfs are robust to unknown physical densities.

Cauchy distributions may thereby be especially useful for assessments of robustness, referring to resistance to errors in results produced by noise and/or outliers. Measured noise may take various forms such as measurement noise (noise resulting from sensory instruments) and process noise (natural deviations compared to the “true” value).

In addition to being light-tailed, Gaussian probability density functions (pdfs) are an example of stable probability distributions. Stable distributions refer to distributions that can also be represented as linear combinations of two independent random variables with the same distribution type. As such, stable probability distributions can be defined by four parameters of fit: a stability parameter (0<α≤2) measuring how heavy/light the tail is; a skewness parameter (−1≤β≤1) measuring the asymmetry of the distribution; a scale parameter (0<σ<∞) measuring the dispersion/width; and a location parameter (−∞<μ<∞) measuring the peak of the distribution.

Alternatively, characteristic functions may refer to any type of random variable that completely represents the distribution of a random variable. In assessing random variables, systems may incorporate realizations that result from applying the random variable to observed outcomes of random experiment(s).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 conceptually illustrates a process for updating parameters of a characteristic function in accordance with some embodiments of the invention.

FIG. 2 illustrates several hyperplane arrangements determined in accordance with numerous embodiments of the invention.

FIG. 3 illustrates a sliding window bank for multiple estimators configured in accordance with certain embodiments of the invention.

FIGS. 4-5C conceptually illustrate an example scenario addressed by utilizing methods in accordance with multiple embodiments of the invention.

FIG. 6 illustrates a comparison, under various heavy-tailed systems, of outputs from Extended Kalman Filters and Extended Multivariate Cauchy Estimators configured in accordance with many embodiments of the invention.

### DETAILED DESCRIPTION

Turning now to the drawings, systems and methods for linearly parameterizing compressed characteristic functions of Multivariate Cauchy Estimators (MCE), in accordance with various embodiments of the invention, are disclosed. Multivariate Cauchy Estimator algorithms can enable robust state estimation performance for applications where various system noises are too volatile to be accurately represented in Gaussian distributions. Multivariate Cauchy Estimators are disclosed in M. Idan and J. L. Speyer, “Multivariate Cauchy estimator with scalar measurement and process noises,” SIAM Journal on Control and Optimization, vol. 52, no. 2, 2014, incorporated by reference herein in the entirety.

Closed-form distributions refer to distributions that can be represented near-exactly with finite, commonplace terms and/or parameters. Heavy-tailed distributions are rarely represented in closed-form expressions because, as the heaviness of tails increases, the probability of outliers increases as well. As a number of natural phenomena (e.g., earthquakes, atmospheric turbulence) can be represented by heavy-tailed distributions, the phenomena generally are not represented in closed-form distributions. Instead, systems in accordance with numerous embodiments of the invention may apply conditional probability distribution functions (cpdf) of a given system based on the measurement history of the given system.

As Cauchy pdfs do not have a defined mean and have infinite variance, the capacity to be accurately represented through closed-form distributions is limited. Systems configured in accordance with certain embodiments of the invention may circumvent this concern by using the conditional density of Cauchy random variables which, given their linear measurements with noise (also following a Cauchy distribution), may produce known conditional means and finite conditional variances. In such cases, both conditional mean and conditional variance may be functions of the determined measurements. Therefore, systems configured in accordance with certain embodiments of the invention may be used for solving multivariate state-estimation problems where both process and/or measurement noises are modeled by MCEs. The process and measurement noises may be modeled as (additive) heavy-tailed Cauchy random variables represented as characteristic functions of the unnormalized conditional probability density function (ucpdf) produced by the measurement noises and process noises as represented in obtained measurement values. In accordance with a number of embodiments of the invention, characteristic functions may be recursively updated in real-time.

Systems and methods configured in accordance with some embodiments of the invention may reduce processing burdens faced by characteristic functions. In particular, some implementations of characteristic functions may be composed of a number of factorially generated terms at each estimation step, wherein each of the terms are dependent upon all past terms generated at each estimation time step. In such cases, characteristic functions may be represented in the form of backward recursive “tree-like structures” for which child terms are functions of past parent terms and/or past parameters.

In accordance with many embodiments of the invention, terms including but not limited to conditional means and variances may be determined without being dependent on terms of past characteristic functions. In such cases, similar terms of a current estimation step's characteristic function could be combined together, saving vast amounts of computer memory and computation over time. The specifics of the formulae applied for such algorithms, as configured in accordance with many embodiments of the invention is expounded upon in N. Snyder, M. Idan, and J. L. Speyer, “Real-Time Robust Multivariate Estimator for Dynamic Systems with Heavy-Tailed Additive Uncertainties,” incorporated by reference in its entirety.

### I. Compression

Systems and methods configured in accordance with some embodiments of the invention may reduce processing burdens faced by characteristic functions through compressing the characteristic functions. In particular, when deriving terms for conditional pdfs, including but not limited to conditional means and covariances, state estimators configured in accordance with numerous embodiments of the invention may recursively update function parameters while minimizing the processing required. In particular, compression of characteristic functions may utilize cell-enumeration algorithms, wherein the process and measurement noises can be modeled as additive heavy-tailed Cauchy random variables.

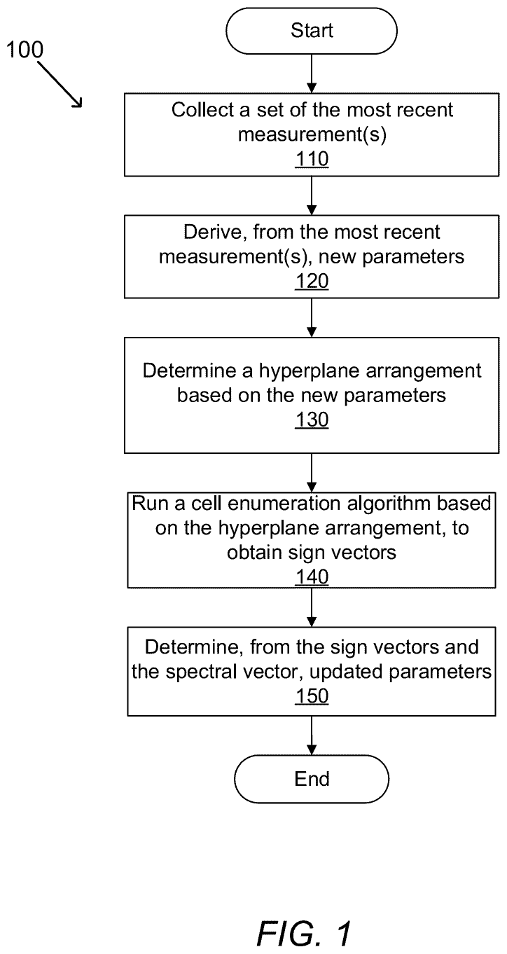

A process for implementing a compressed characteristic function in accordance with some embodiments of the invention is illustrated in FIG. 1. Process 100 collects (100) a set of the most recent (sensory) measurement(s), corresponding to the current time t. Prospective measurements may reflect various detectable states of a given system, including but are not limited to distance measurements, bearing measurements, and/or motion measurements. Process 100 derives (120), from the most recent measurement(s), new parameters corresponding to the most recent estimation step.

Process 100 updates (130) a hyperplane arrangement based on the new parameters. In accordance with numerous embodiments of the invention, hyperplanes may refer to classification-based transformation kernels including subspaces of one dimension less than the input space. Hyperplane arrangements may encompass compositions of finite sets of hyperplanes in spaces including but not limited to linear, affine, and projective space. Application of hyperplanes to linear systems are disclosed in N. Duong, M. Idan, R. Pinchasi, and J. Speyer, “A note on hyper-plane arrangements in Rd,” Discrete Mathematics Letters, vol. 7, pp. 79-85, July 2021, incorporated by reference in its entirety. The application of hyperplane arrangements to characteristic functions is disclosed in N. Snyder, M. Idan, and J. L. Speyer, “Distributed computation of a robust estimator based on cauchy noises,” in 2021 60^{th} IEEE Conference on Decision and Control (CDC), 2021, pp. 6584-6590, incorporated by reference in its entirety. In accordance with several embodiments of the invention, characteristic functions may be represented by multiple terms, where each term i contains a central arrangement of m-hyperplanes in dimension d. These terms may involve complex-valued functions constant in each cell of this hyperplane arrangement.

Process 100 runs (140) a cell enumeration algorithm based on the hyperplane arrangement to obtain sign vectors for each of the cells. The entire set of sign vectors of a hyperplane arrangement may be obtained by running a cell-enumeration algorithm using a sequence of linear programs. Specifically, a sign vector function, constructed by an inner product, of the parameters obtained in (120) and a spectral vector, may be used to determine in which half-space the spectral vector lies with respect to every hyperplane in the arrangement. In accordance with many embodiments of the invention, the cell enumeration algorithms may produce finite numbers of values, and take on only as many values as there exist cells in the hyperplane arrangement. In accordance with many embodiments, the sign vectors may be grouped into basis matrices, wherein each row of a basis matrix corresponds to a cell of the hyperplane arrangement. Process 100 determines (150), from the sign vectors and the spectral vector, updated parameters for the compressed characteristic function wherein the updated parameters are represented as a linear combination of the rows of the basis matrix. As suggested above, cells of hyperplane arrangements, referring to regions in space the region in space where varying the value of spectral vectors leaves the sign vector unchanged, can thereby be uniquely defined by their sign vectors.

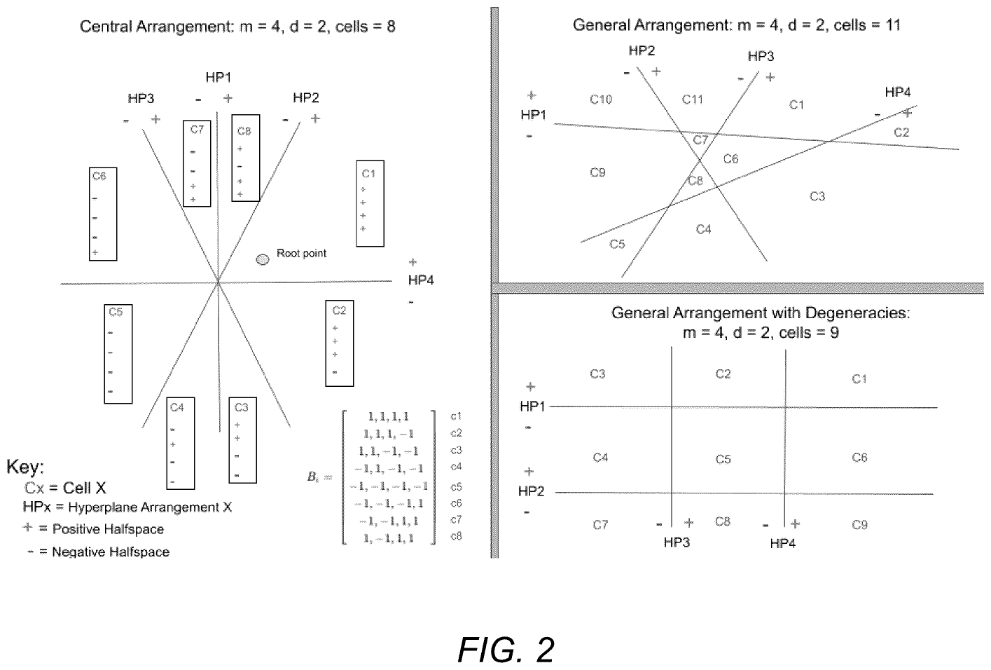

Cells and sign vectors of several two-dimensional hyperplane arrangements, determined in accordance with numerous embodiments of the invention, are illustrated in FIG. 2. As illustrated in the figure, cell enumeration algorithms for hyperplane arrangements can be categorized into two classes: general (when the planes do not intersect with the origin) and central (when they do). Additionally or alternatively, hyperplane arrangements may be non-degenerative (when there are no parallel hyperplanes) and degenerative (when there are). While two arrangements may contain the same number of hyperplanes, various geometrical patterns can create degeneracies and reduce the total number of cells in the arrangement.

FIG. 2 illustrates cell enumeration examples of 4 hyperplanes in 2 dimensions for general (top right, 11 cells), central (left, 8 cells), and degenerate (bottom right, 9 cells) arrangements. The figure also depicts the hyperplane half-spaces (+/−signs) and cell sign vectors (boxed vectors). By varying spectral vectors over an entire domain, one could thereby obtain the entire set of sign vectors that uniquely locate all cells of a respective hyperplane arrangement. Practically, the entire set of sign vectors of a hyperplane arrangement (central and/or general) may be obtained by running a cell-enumeration algorithm as described above, which can use a sequence of linear programs to find the sign vectors (and therefore cells).

Although the compressed structure of the characteristic function may reduce memory consumption and allows for similar terms to be combined, the number of terms after a measurement update can still grow, albeit more slowly. A method, termed the sliding window approximation, may allow two-state linear systems to cap growth rates and run estimation structures continuously with a fixed computation load per estimation step. A sliding window approximation method that may be utilized in accordance with embodiments of the invention is disclosed in J. Fernández, J. L. Speyer, and M. Idan, “Stochastic estimation for two-state linear dynamic systems with additive Cauchy noises,” IEEE Transactions on Automatic Control, vol. 60, no. 12, 2015, incorporated by reference in its entirety.

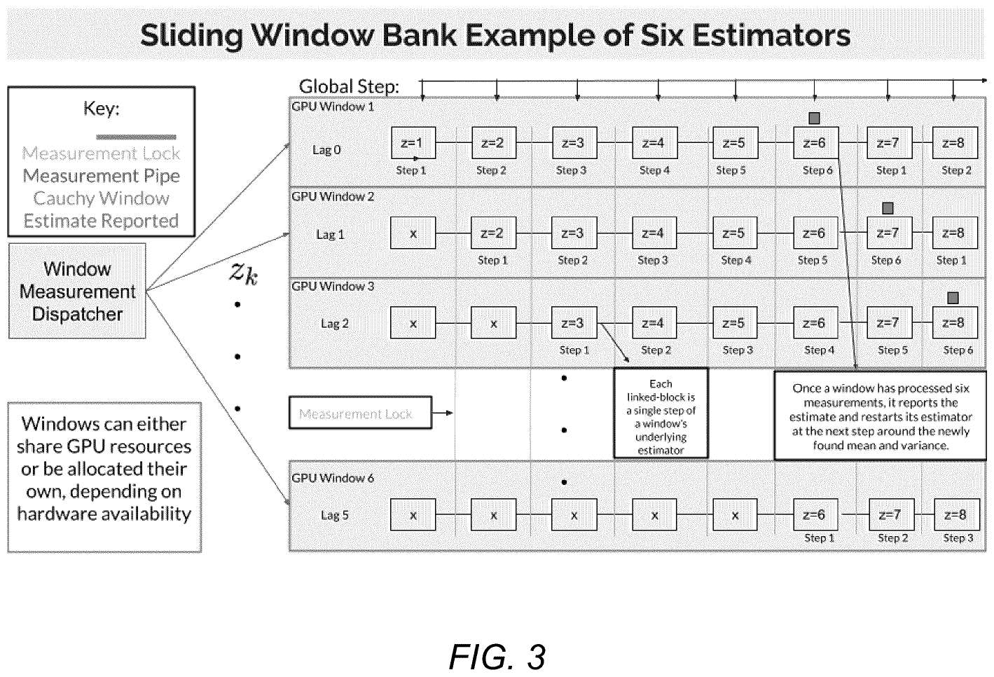

A proposed structure for a system of multiple estimators and sliding windows in accordance with numerous embodiments of the invention is illustrated in FIG. 3. To run the MCE continuously for arbitrarily long simulations, a bank of W estimators processing data over sliding windows may be instantiated. Each estimator may have a processing capacity of W sensor measurements. In accordance with some embodiments, the data windows may be staggered by one or more estimation steps. Only the estimator that processed W sensor measurements at a specific time step k may need to report its estimation result, following which it can be restarted. Subsequently, the neighboring estimator that has processed W measurements at time step k+1 can report its mean and covariance at that instant.

In accordance with numerous embodiments of the invention the MCEs may, additionally or alternatively be applied to nonlinear systems to contrast the methodology of extended Kalman filters (EKFs). The application of such methods to nonlinear systems are disclosed in N. Snyder, M. Idan, and J. L. Speyer, “Real-Time Robust Multivariate Estimator for Dynamic Systems with Heavy-Tailed Additive Uncertainties,” incorporated by reference in its entirety.

### II. Implementations

In accordance with many embodiments of the invention, MCE algorithms and/or implementations of sliding window approximations can be implemented in CUDA-C/C++ for parallel processing and evaluation of the characteristic function. In accordance with a number of embodiments, MCEs may be independent and/or computed efficiently in parallel. Additionally or alternatively, sliding windows may be implemented as a host side (CPU) C and/or C++ process that can manage single device-side (GPU) MCE instances. Each MCE may be responsible for synchronizing with all other MCEs as the sensor measurements become available. In accordance with certain embodiments MCEs can share the same underlying GPU and/or use their respective GPUs, depending upon GPU availability. The data of the windows can furthermore reside on the same computer node and/or be dispersed across multiple compute nodes and coordinated via socket communication over a local area network. This heterogeneous (CPU/GPU) application design can allow for MCEs to be highly extensible to high-performance computing (HPC) clusters, where applications can be dispersed across multiple computer nodes with multiple CPU hosts managing multiple GPU devices. GPU devices utilized in accordance with several embodiments of the invention may include but are not limited to NVIDIA devices.

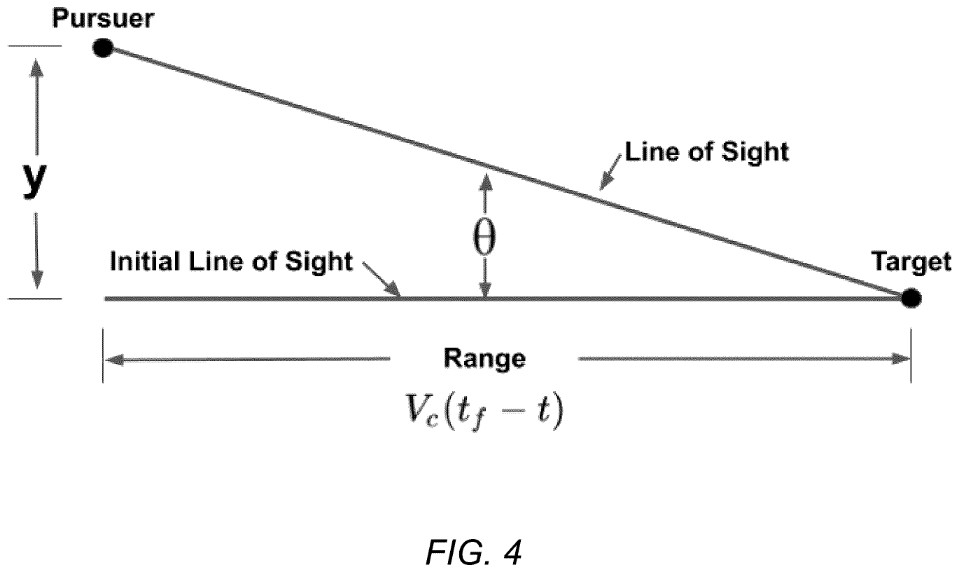

As discussed above, MCEs configured in accordance with certain embodiments of the invention may be applied to various linear or nonlinear dynamic systems, for example, a target-pursuer homing missile problem, modelled as depicted in FIG. 4. The pursuer's estimation objective may be to use an onboard radar sensor to estimate the relative lateral position and/or velocity between itself and a given target. Additionally or alternatively, the lateral acceleration of the target may be estimated. Onboard radar may provide a noisy line-of-sight bearing measurement between itself and the relative lateral and longitudinal distance to its target. These measurements may be provided to the pursuer as it longitudinally closes in on the target and until the time-to-intercept reaches zero.

In accordance with a number of embodiments, noise distribution associated with the radar sensor(s) can be modelled as a S-α-S pdf with a certain stability parameter (e.g., α=1.7). Additionally or alternatively, the distribution may follow a time-varying fading, scintillation and glint noise model that is inversely proportional to the time-to-intercept. In such circumstances, the target can be modelled with non-Gaussian distributions, forcing evasive maneuvers by simulating the acceleration profile of the target as a telegraph wave with Poisson-distributed switching times. The telegraph (forcing) wave, although non-Gaussian, may admit finite first and/or second moments. In accordance with various embodiments the telegraph forcing may be modelled to have two or modes including but not limited to a long primary mode (e.g., ±3G amplitude) and a shortly sustained secondary mode (e.g., ±9G amplitude), where G stands for the acceleration due to gravity. Systems and methods in accordance with some embodiments of the invention may thereby be applied to obtain values for state estimation and/or state estimation error.

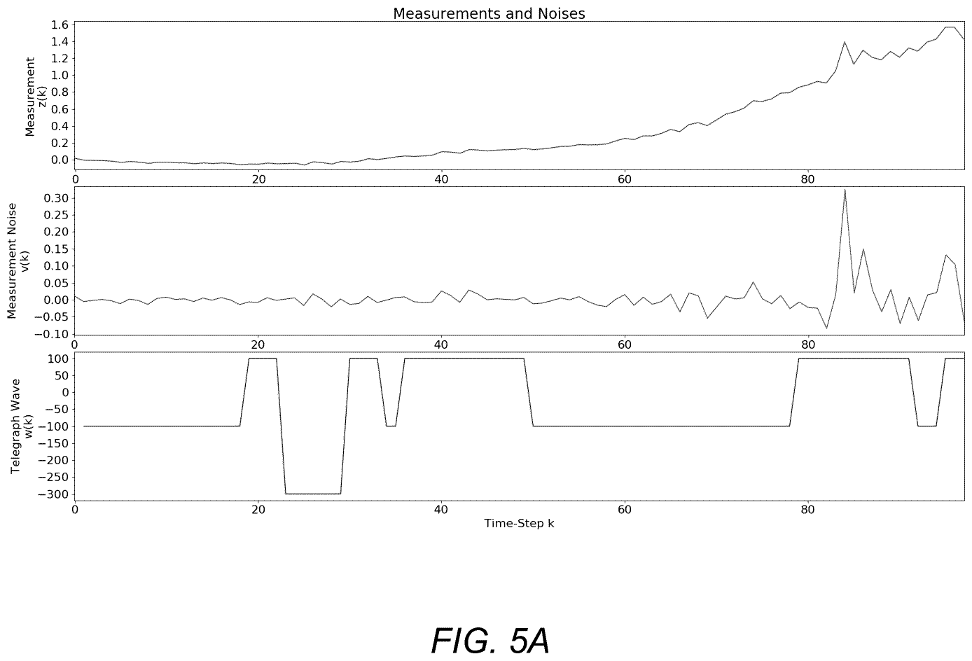

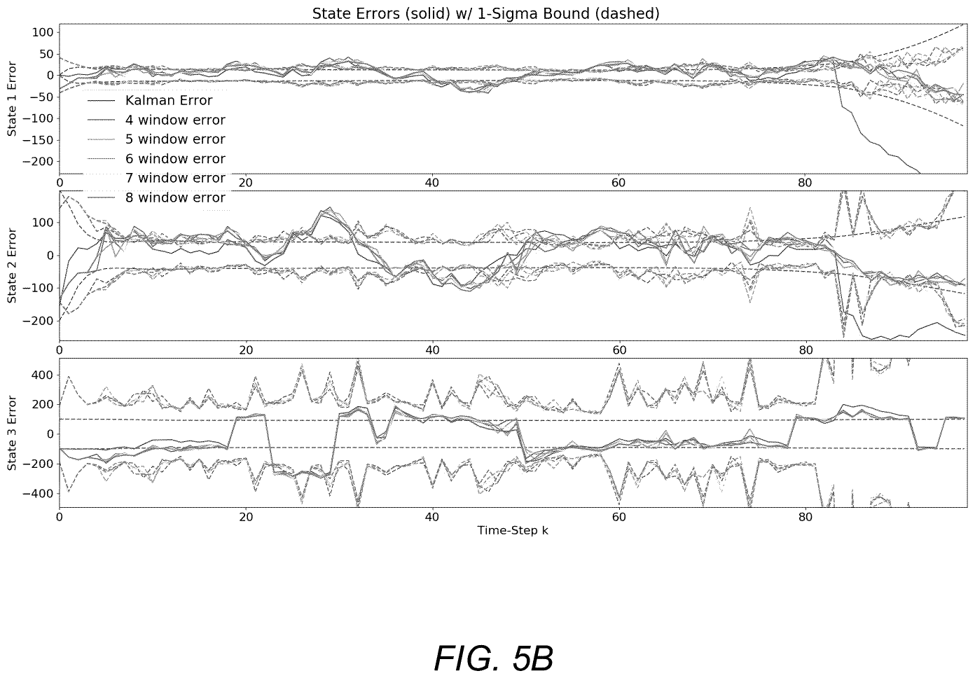

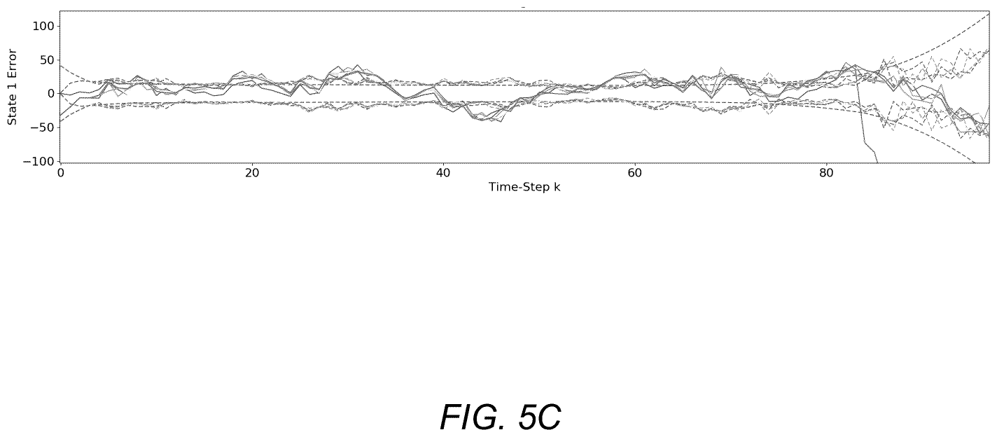

Simulation input data for such an experiment, conducted in accordance with several embodiments of the invention, is illustrated in FIG. 5A. The top subplot shows the simulated line-of-sight bearing angle measurement provided to the pursuer homing missile by its onboard radar sensor. The middle subplot shows the S-α-S radar noise with α=1.7. The bottom subplot depicts the acceleration profile of the target, simulated as a telegraph wave.

The performance of the EMCE for this sample run, performed in accordance with numerous embodiments of the invention, and as compared to an Extended Kalman Filter (EKF) performance are presented in FIG. 5B. Depicted are the state-estimation errors for the relative lateral position (top) and relative lateral velocity (middle) between the target and its pursuer. The lateral estimation error for the telegraph acceleration profile of the target is depicted in the bottom subplot. The dashed green line depicts the EKF's predicted, one standard deviation, confidence bound of its estimate. The other dashed lines are the one standard deviation confidence bounds for the EMCE window banks. The horizontal axis for both FIGS. 5A and 5B is the time step, where at t=10 sec the pursuer catches up longitudinally with its target. FIG. 5B shows that both estimators appear to estimate the relative position and velocity similarly for the first 80 time steps, while both struggle to determine the telegraph acceleration. As the pursuer closes in longitudinally, the nonlinearity of the measurement model will become more pronounced because longitudinal deviations at close distances affect the bearing angle measurement more severely. FIG. 5A shows that, at time step 84 when the pursuer is longitudinally close to its target, an impulse in the radar measurement noise is observed. The EKF reacts strongly to this impulse, while all EMCE window banks are seen to ignore the impulse.

Due to the nonlinearity in the measurement model, the EKF is not able to recover from the outlier and its estimate of relative lateral position continues to diverge severely until the end of the experiment. This is caused by the fact that the linearization of the measurement model in the EKF is taken about the state estimate, which continues to worsen. From time step 84 and on, all of the EMCE window banks remain within their predicted one standard deviation confidence bounds, while the EKF state-estimate error diverges far outside of its predicted confidence bound in both relative lateral position and velocity. Moreover, the confidence bound of all EMCE window banks for relative lateral position crosses inside that of the EKF confidence bound. This is possible because the EMCE covariance is a function of the measurement itself, and can adjust dynamically to its measurement history.

FIG. 5C shows a magnified illustration of the state error in the relative position given in FIG. 5B. The performance of the EKF and EMCE is similar when the noise is close to Gaussian, as seen in FIGS. 5A and 5C for the first 80 time steps. Moreover, there does not seem to be a large performance increase from using a sliding window bank of the last four measurements to a sliding window bank of the last eight measurements. All window bank sizes perform competitively to the EKF in the first 80 time steps, and all window banks are seen to greatly outperform the EKF once any heavy-tailed noise is observed. This implies that, with only a very slight loss of estimation accuracy, one could trade off larger window bank sizes for faster execution speeds. We see that the practical advantage of the EMCE for nonlinear systems is that the estimator stays robust to heavy-tailed noises and outliers in the measurement (or the process), which could otherwise cause large divergences or even failures to an EKF, as demonstrated by FIG. 5B.

In accordance with multiple embodiments of the invention, Monte Carlo trials may be used to verify the robustness properties of the EMCE over the EKF by subjecting both estimators to multiple heavy-tailed environments.

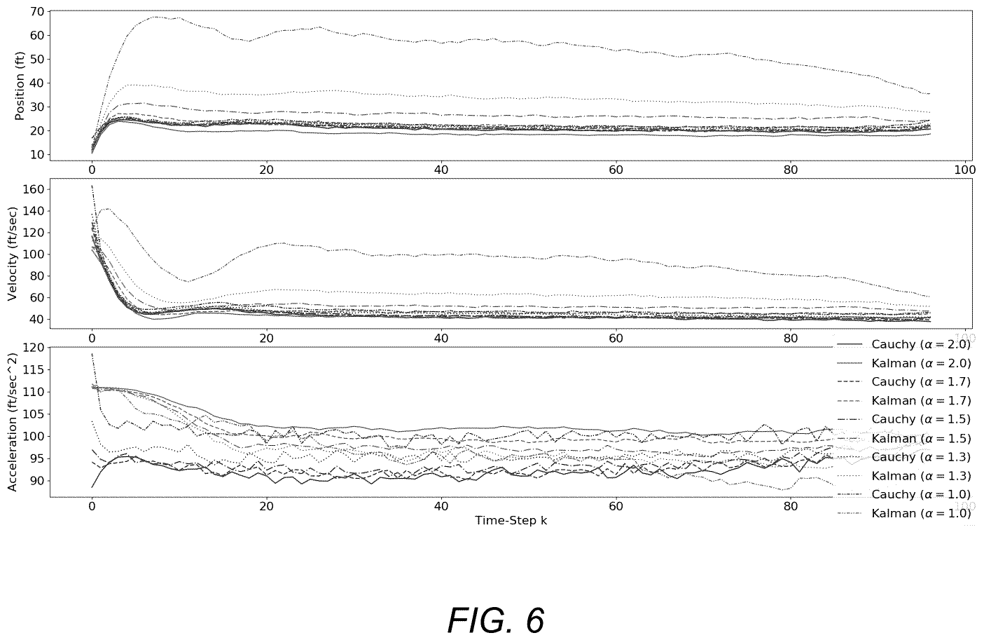

The performance of the EKF against the EMCE, configured in accordance with numerous embodiments of the invention, for a modest window bank size of seven, is illustrated in FIG. 6. There is minimal change observed in the performance index for the EMCE in the relative position and velocity as a is lowered from 2.0 to 1.0, while the EKF degrades dramatically. In accordance with some embodiments, the EMCE is superior for all heavy-tailed noise levels tested in relative position and velocity. We conclude that the Cauchy estimator appears to either be or close to a minimum variance estimator over the class α∈[1, 2]. In this sense, the EMCE may be considered to be robust.

Both estimators struggle to estimate the acceleration state of the target, for which the Monte Carlo trials do not produce convergent results for heavy-tailed noise α<2.0 as they do for the relative position and velocity.

FIGS. 5B and 6 both suggest that the net benefits of the EMCE for heavy-tailed noise environments include but are not limited to: that near identical performance relative to the EKF is expected during periods of time when the noise is effectively Gaussian; that superior performance is expected when the noise becomes more volatile than the Gaussian distribution suggests; and that the EMCE is expected to stay robust and help safeguard against modes of failure that can otherwise occur during nonlinear system estimation, as demonstrated by step 84 of FIG. 5B. Additionally or alternatively, unlike the Kalman filter, FIG. 6 implies that regardless of how heavy-tailed the noise characteristics can become, the mathematical structure of the Cauchy estimator may allow it to remain resilient to outliers of varying magnitudes and with negligible impact on its performance index.

### III. Theoretical Background

The disclosed estimation algorithm enables robust state estimation performance for applications where the system noises are more volatile than the Gaussian distribution suggests. This is achieved by over-bounding realistic process and measurement noises with additive, heavy-tailed Cauchy random variables. The characteristic function of the un-normalized conditional probability density function is propagated as a growing sum of terms in the MCE. Here, the characteristic function is enhanced by replacing the original recursive, or tree-like evaluation procedure through a representation of linear parameter vectors that operate on bases functions. This insight can lead to eliminating over 99% of terms that previously comprised this characteristic function. Through the use of graphical processing units, the MCE is able to exploit its parallel mathematical structure and achieve real-time performance. Monte Carlo simulations reveal that the estimation performance is notably robust over a large range of impulsive uncertainties.

Given the discrete-time linear dynamic system

$${x}_{k + 1} = {Φ}_{k} {x}_{k} + \text{?} , \qquad ( 1 a )$$

$${z}_{k} = {H}_{k} {x}_{k} + \text{?} , \qquad ( 1 b )$$

$$\text{?} \text{indicates text missing or illegible when filed}$$

with xₖ representing the system-state vector at estimation step k, the transition matrix ϕₖ the process-noise vector of heavy-tailed Cauchy random variables wₖ and the control matrix Γₖ. The measurement vector may be is modelled with Hk and Cauchy noise vk. Here, ϕₖ, Γₖ, Hₖ can either be time-invariant or time-varying. The vectors x₁, wₖ, vₖ may be modeled as independent and heavy-tailed realizations of Cauchy random variables.

The goal of the estimation problem is to determine the conditional mean and covariance of the system state-vector Xₖ given the measurement history Yₖ={Z₁, . . . , Zₖ} at estimation step k. Note that Xₖ, Yₖ, Zk are used to represent the random vectors while xₖ, yₖ, zₖ represent their realizations. The cpdf of the system state-vector at step k given the measurement history realization yk={z₁, z₂, . . . , zₖ} can be written generally as

$${f}_{{X}_{k} \vert {Y}_{k}} ( {x}_{k} \vert {y}_{k} ) = \frac{{f}_{{X}_{k} , {Y}_{k}} ( {x}_{k} , {y}_{k} )}{{f}_{{Y}_{k}} ( {y}_{k} )} = \frac{\text{?} ( \text{?} \vert \text{?} ) \text{?} ( {x}_{k} \vert {y}_{k - 1} ) \text{?} ( {y}_{k - 1} )}{\text{?}} , \qquad ( 2 )$$

$$\text{?} \text{indicates text missing or illegible when filed}$$

Since the propagation of the cpdf for scalar linear systems with additive Cauchy noises could not be extended to multivariate systems, it has been shown that the characteristic function of the ucpdf of the multivariate system exists and can be expressed generally at any estimation step k as

$$\begin{matrix}\text{?} = {\int }_{- ∞}^{∞} \text{?} ( {x}_{k} , {y}_{k} ) \text{?} {dx}_{k} \\ = \text{?} ( \text{?} ( \text{?} ) exp ( \text{?} ( \text{?} ) )\end{matrix} \qquad ( 3 )$$

$$\text{?} \text{indicates text missing or illegible when filed}$$

The characteristic function is expressed as a sum of terms. Each term is a product between complex-valued functions of the spectral variable v given by

$${g}_{i}^{k \vert k} ( {y}_{gi}^{k \vert k} ( v ) ) = \frac{1}{2 π} [ \frac{\text{?} ( \text{?} ( v ) + {h}_{i}^{k \vert k} )}{\text{?} + {d}_{i}^{k \vert k} + \text{?} ( v )} - \frac{\text{?} ( \text{?} ( v ) - {h}_{i}^{k \vert k} )}{\text{?} - {d}_{i}^{k \vert k} + \text{?} ( v )} ] , \qquad ( 4 )$$

$$where$$

$$\text{?} ( v ) = {( {ϱ}_{i}^{k \vert k} )}^{T} {λ}_{i}^{k \vert k} ( v ) ∈ {ℝ}^{k - 1} , \qquad ( 5 a )$$

$${ϱ}_{i}^{k \vert k} ∈ {ℝ}^{( k - 1 ) \times {m}_{i}^{k \vert k}}$$

$$\text{?} ( v ) = {( {q}_{i}^{k \vert k} )}^{T} {λ}_{i}^{k \vert k} ( v ) ∈ ℝ , {q}_{i}^{k \vert k} ∈ {ℝ}^{{m}_{i}^{k \vert k}} \qquad ( 5 b )$$

$$\text{?} ( v ) = sgn ( 〈 \text{?} , v 〉 ) , \qquad ( 5 c )$$

$$l ∈ [ 1 , … , {m}_{i}^{k \vert k} ] ,$$

$${λ}_{i}^{k \vert k} ( v ) ∈ {ℝ}^{{m}_{i}^{k \vert k}} ,$$

$$and an exponent of$$

$$\text{?} ( v ) = \text{?} \vert 〈 \text{?} , v 〉 \vert + j 〈 {b}_{i}^{k \vert k} , v 〉 ∈ ℂ , \qquad ( 5 d )$$

$$\text{?} \text{indicates text missing or illegible when filed}$$

The normalization factor of (2) and (3) is given by

$${f}_{{Y}_{k}} ( {y}_{k} ) = {\overline{ϕ}}_{{X}_{k} \vert {Y}_{k}} ( v ) {\vert}_{v = 0} = \text{?} ( \text{?} ( v ) ) \text{?} ∈ ℝ \text{?} \qquad ( 6 )$$

$$\text{?} \text{indicates text missing or illegible when filed}$$

The conditional mean and estimation error covariance are constructed from the first and second derivatives, respectively, of the characteristic function. They are given by

$${\hat{x}}_{k} = \frac{1}{\text{?} {f}_{{Y}_{k}}} \text{?} ( \overline{v} ) \text{?} ( \overline{v} ) ∈ {ℝ}^{d} , \qquad ( 7 )$$

$${P}_{k} = - \frac{1}{{f}_{{Y}_{k}}} \text{?} {g}_{i}^{k \vert k} ( \overline{v} ) {\overline{y}}_{ei}^{k \vert k} ( \overline{v} ) {( \text{?} ( \overline{v} ) )}^{T} - {\hat{x}}_{k} {\hat{x}}_{k}^{T} ∈ {ℝ}^{d \times d} , \qquad ( 8 )$$

$$with$$

$${\overline{y}}_{ei}^{k \vert k} ( \overline{v} ) = - \text{?} ( \overline{v} ) \text{?} + {jb}_{i}^{k \vert k} ∈ {ℂ}^{d} , \qquad ( 9 )$$

$$\text{?} \text{indicates text missing or illegible when filed}$$

As noted above, the evaluation of this characteristic function is computationally challenging for two main reasons. First, (4) is recursive and requires storing the parameters of all past characteristic functions of steps [1, . . . , k−1] in computer memory. Second, at each successive estimation step k+1 (after a measurement is processed) the number of terms in the characteristic function becomes

$$\text{?} = \text{?} ( {m}_{i}^{k + 1 \vert k} + 1 ) , \qquad ( 10 )$$

$${m}_{i}^{k \vert k} \leq {m}_{i}^{k + 1 \vert k} \leq {m}_{i}^{k \vert k} + \text{?} . \qquad ( 11 )$$

$$\text{?} \text{indicates text missing or illegible when filed}$$

An inspection of (4) shows that its argument given in (5b) is a function of sign. These sign functions are constructed by an inner product of certain parameters and the spectral vector v. The parameters can be thought of as a central arrangement of hyperplanes, operated upon by v. The sign-vector of (5c) then determines which halfspace a given v lies in with respect to every hyperplane in the arrangement. Relatedly, a cell is the region in space where varying the value of v leaves the sign-vector unchanged. A cell of a hyperplane arrangement, therefore, is uniquely defined by its sign vector. This is visualized in FIG. 1, where the cells and sign-vectors of two-dimensional central and general arrangements are depicted.

It can be reasoned from FIG. 1 that by varying v over the entire domain, one could obtain the entire set of sign-vectors that uniquely locate all cells of a respective hyperplane arrangement. Practically, the entire set of sign vectors of a hyperplane arrangement (either central or general) is obtained by running a cell-enumeration algorithm, which uses a sequence of linear programs to find the sign vectors (and therefore cells). Equation (4) produces a finite number of values, and explicitly, takes on only as many values as there exist cells in the arrangement.

Let A be a hyperplane arrangement of m affine hyperplanes Hi, i∈1, . . . , m in Rn and σi(v) be the indicator function of the open halfspaces of Hi. Since g(v) is a function that is constant in the interior of every cell, there is a linear combination of products of n or less of the functions σi(v) that is equal to g(v). Thus:

$$g ( v ) = {\sum }_{\vert I \vert \leq n} {α}_{I} {σ}_{I} ( v ) , \qquad ( 12 )$$

or, equivalently,

$$g ( v ) = {\sum }_{\vert I \vert = n} {α}_{I} {σ}_{I} ( v ) + {\sum }_{\vert I \vert < n} {α}_{I} {σ}_{I} ( v ) . \qquad ( 13 )$$

Although the compressed structure of the characteristic function reduces memory consumption and allows for similar terms to be combined, the number of terms after a measurement update will still grow, albeit now more slowly. A method, termed the sliding window approximation, has been proposed for two-state linear systems to cap the growth rate and run the estimation structure continuously with a fixed computation load per estimation step. The method is explained in this section and generalized to multivariate systems.

To run the MCE continuously and for arbitrarily long simulations, a bank of W estimators processing data over sliding windows (i.e., MCEs) is instantiated. Each estimator has a processing capacity of W sensor measurements. Clearly, W dictates the computational load of the filter-bank and is set a-priori to account for the computing power at hand. The data windows are staggered by one estimation step. Only the estimator that processed W sensor measurements at a specific time step k will report its estimation result, following which it will be restarted using the procedure detailed below. Subsequently, the neighboring estimator that has processed W measurements at time step k+1 will report its mean and covariance at that instant. FIG. 2 illustrates the proposed schematic for an example of six estimators and thus six sliding windows.

A formula has been derived to initialize the characteristic function of two-state linear systems to generate a desired mean and covariance, given the measurement value, over one estimation step. This formula was useful for the MCE for a two-state system using the sliding window approximation. It allowed the “restarted” window to reconstruct the estimate found by the “full” window of W MCE at each estimation step. In this way, each restarted window would be initialized about the current estimate that is computed using the previous W measurements. The initialization formula, however, was not generalizable to the multivariate case. This issue is resolved next.

The procedure for initializing the MCE using the sliding window approximation is now developed explicitly. Let the window length be W and therefore there are also W windows. After processing W measurements in window w E W at time step k, the associated MCE computes the resulting conditional mean and error variance. Now, this MCE has to be initialized before it processes the next measurement at k+1. It is suggested that this initialization is constructed such that after processing the measurement at k+1, the resulting conditional mean and error variance are the same as those computed by the neighboring MCE that has processed W measurements at this time instance. We start with the form of the characteristic function, before the initial measurement update, given as

$$\text{?} = exp [ ( - {\sum }_{ℓ = 1}^{n} {p}_{ℓ}^{1} \vert 〈 {a}_{ℓ}^{1} , v 〉 \vert ) + j 〈 {b}^{1} , v 〉 ] \qquad ( 14 )$$

$$\text{?} \text{indicates text missing or illegible when filed}$$

with initialization parameters. The initial set of hyperplanes A should be chosen as orthonormal vectors, but not necessarily as unit vectors. Given the constraints on A, the key idea is that the parameter set {A, p1, b1} is now chosen such that updating the characteristic function with a single measurement z∈R (via a measurement update) will generate a conditional mean and covariance equal to that of the neighboring MCE of W measurement updates. Based on the results of the derivations presented in the Appendix, this condition is met if the matrix A satisfies

$${A}^{T} Ψ A = \text{?} \qquad ( 15 )$$

$$\text{?} \text{indicates text missing or illegible when filed}$$

where

$$Ψ = P + \frac{{PH}^{T} HP}{{γ}^{2} + {( \text{?} - H \hat{x} )}^{2}} ∈ {ℝ}^{n \times n} , \qquad ( 16 )$$

$$\text{?} = \text{?} [ \begin{matrix}\frac{\text{?}}{\text{?}} & 0 & … & 0 \\ 0 & \frac{\text{?}}{\text{?}} & … & 0 \\ ⋮ & ⋮ & ⋱ & ⋮ \\ 0 & … & 0 & \frac{\text{?}}{\text{?}}\end{matrix} ] ∈ {ℝ}^{n \times n} , \text{?} , \text{?} ∈ \text{?} \qquad ( 17 )$$

$$\text{?} = \frac{{γ}^{2} + {( \text{?} - H \text{?} )}^{2} + {HPH}^{T}}{γ} ∈ ℝ , \qquad ( 18 )$$

$$\overline{p} = \frac{γ HPA}{{γ}^{2} + {( \text{?} - H \hat{x} )}^{2}} ∈ {ℝ}^{n} , \qquad ( 19 )$$

$$\text{?} = HA ∈ {ℝ}^{1 \times n} \qquad ( 20 )$$

$${p}_{ℓ}^{1} = {\overline{p}}_{ℓ} / sgn ( \text{?} ) ∈ \text{?} , \qquad ( 21 )$$

$$ℓ ∈ \{ 1 , … , n \text{?}$$

$${b}^{1} = \hat{x} - \frac{( \text{?} - \text{?} ) {PH}^{T}}{{γ}^{2} + {( \text{?} - H \text{?} )}^{2}} ∈ \text{?} , \qquad ( 22 )$$

$$\text{?} \text{indicates text missing or illegible when filed}$$

and γ is the Cauchy pdf modeling parameter for the measurement noise of (1). Above, ψ is a positive definite matrix, which is a function of the conditional mean and covariance of the (full) neighboring MCE. The important observation is that the left side of (15) must be equal to a diagonal matrix. Since the left-hand side of (15) is a positive definite matrix ψ and ∧ a positive diagonal matrix, the rotation needed is simply the eigenvectors of ψ, which for this positive definite matrix are real and orthogonal. Thus, ∧ contains the eigenvalues of ψ in diagonal matrix form.

Since the MCE is formulated for linear systems with additive Cauchy noise, the extension to nonlinear systems follows the methodology of the extended Kalman filter. Consider the discrete-time nonlinear dynamic system as:

$${x}_{k + 1} = f ( {x}_{k} , {u}_{k} ) + {Γ}_{k} \text{?} \qquad ( 23 )$$

$$\text{?} = \text{?} ( {x}_{k} ) + \text{?} , \qquad ( 24 )$$

$$\text{?} \text{indicates text missing or illegible when filed}$$

where the elements of the initial state x1 are independent and Cauchy distributed, uk is a deterministic control, f, h are nonlinear functions, Γₖ is a weighting matrix on the independent vector of process noise wₖ and zₖ is the measurement modeled with an independent Cauchy noise vector vₖ. Note that (23) is the nonlinear version of (1) without the added control input.

To derive the extended form of the Cauchy estimator, we assume that an estimate at step k given the measurement history yₖ has been obtained and the estimate at k+1 is to be determined. Projecting the posterior state estimate, using the system dynamics of (23), is the a priori state

$${𝔼}_{[ {x}_{k + 1} \vert {y}_{k} ]} \approx \text{?} = f ( \text{?} , {u}_{k} ) . \qquad ( 25 )$$

$$\text{?} \text{indicates text missing or illegible when filed}$$

The state variation can be formed by comparing the system dynamics (23) with the propagation of the conditional mean (25), to yield

$${δ}_{{x}_{k + 1 \vert k}} = {x}_{k + 1} - {x}_{k + 1} = 𝒻 ( {x}_{k} , {u}_{k} ) - 𝒻 ( {x}_{k} , {u}_{k} ) + {Γ}_{kWk} \approx {▽𝒻}_{x} ( {x}_{k} , {u}_{k} ) \vert \text{?} δ \text{?} + ▽ \text{?} ( {x}_{k} , {u}_{k} ) \vert \text{?} δ \text{?} + Γ \text{?} = Φ \text{?} δ \text{?} + Γ \text{?} \qquad ( 26 )$$

$$\text{?} \text{indicates text missing or illegible when filed}$$

At k+1, the perturbed measurement is constructed as

$$\text{?} = \text{?} - \text{?} = h ( {x}_{k + 1} ) - h ( {\overline{x}}_{k + 1} ) + \text{?} \approx ∇ \text{?} + \text{?} = {H}_{k + 1} \text{?} + \text{?} . \qquad ( 27 )$$

$$\text{?} \text{indicates text missing or illegible when filed}$$

Using (26) as the dynamics and processing (27) as the measurement, the MCE is to perform an estimate. The posterior state estimate is obtained as

$$\begin{matrix}\text{?} \approx 𝔼 [ {x}_{k + 1} \vert {y}_{k + 1} ] = {\overline{x}}_{k + 1} + 𝔼 [ {x}_{k + 1} - {\overline{x}}_{k + 1} \vert {y}_{k + 1} ] \\ = 𝔼 [ {x}_{k + 1} \vert {y}_{k} ] + 𝔼 [ {x}_{k + 1} \vert {y}_{k + 1} ] - 𝔼 [ {\overline{x}}_{k + 1} \vert {y}_{k + 1} ] \\ = 𝔼 [ {x}_{k + 1} \vert {y}_{k} ] + 𝔼 [ {x}_{k + 1} \vert {y}_{k + 1} ] - 𝔼 [ 𝔼 [ {x}_{k + 1} \vert {y}_{k} ] [ {y}_{k + 1} ] \\ = 𝔼 [ {x}_{k + 1} \vert {y}_{k} ] + 𝔼 [ {x}_{k + 1} \vert {y}_{k + 1} ] - 𝔼 [ {x}_{k + 1} \vert {y}_{k} ] \\ = 𝔼 [ {x}_{k + 1} \vert {y}_{k + 1} ] .\end{matrix} \qquad ( 28 )$$

$$\text{?} \text{indicates text missing or illegible when filed}$$

The additional computation to extend the MCE to nonlinear systems is in constructing the Jacobian matrices ϕₖ and Hₖ₊₁ at each time-step k.

The parameters of the characteristic function in the MCE must now be updated to account for adding to the a-priori estimate. The characteristic functions of random variables x and y=x+c, where c is a known constant vector, are related as

$${Φ}_{Y} ( v ) = \text{?} {Φ}_{X} ( v ) . \qquad ( 29 )$$

$$\text{?} \text{indicates text missing or illegible when filed}$$

What is claimed is:

1. A method for solving multivariate state-estimation problems, the method comprising:
developing a characteristic function associated with a state estimation problem for a system; and
for a set comprising at least one time point, wherein each time point corresponds to a state in the state estimation problem:
collecting, from a sensory instrument, a set of measurements reflecting the state corresponding to a most recent time point;
deriving, from the set of measurements, new parameters corresponding to the state of the system at the most recent time point;
updating a hyperplane arrangement based on the new parameters;
running a cell-enumeration algorithm based on the hyperplane arrangement to obtain sign vectors for each cell of the hyperplane arrangement; and
determining, based at least in part on the sign vectors, function parameters for updating the characteristic function, wherein the updated characteristic function comprises a linear combination of sign vectors.

2. The method of claim 1, wherein the state estimation problem concerns at least one of:
the relative lateral position between a homing missile and a target; and
the relative velocity between the homing missile and the target.
